(19) United States
(12) Patent Application Publication
(10) Pub. No.: US 2026/0145391 A1
(43) Pub. Date: May 28, 2026

(54) PLASTICIZING DEVICE

(71) Applicant: SEIKO EPSON CORPORATION, Tokyo (JP)

(72) Inventor: Masaaki KINOSHITA, SHIOJIRI-SHI (JP)

(21) Appl. No.: 19/401,632

(22) Filed: Nov. 26, 2025

(30) Foreign Application Priority Data
Nov. 28, 2024 (JP) 2024-207072

(51) Int. Cl. B29C 64/393; B29C 64/106; B29C 64/209; B29C 64/314; B33Y 30/00; B33Y 50/02

(52) U.S. Cl. CPC B29C 64/393; B29C 64/209; B29C 64/314; B33Y 30/00; B33Y 50/02; B29C 64/106

(57) ABSTRACT

A plasticizing device includes a control section that controls at least one of the plasticizing section, the pressure detection section, the suction and discharge section, and the delivery amount adjustment section, wherein the control section causes the plunger pin 220 to stroke at least one of before and after the molding of the molded object.

The present application is based on, and claims priority from JP Application Serial Number 2024-207072, filed Nov. 28, 2024, the disclosure of which is hereby incorporated by reference herein in its entirety.

### BACKGROUND

### 1. Technical Field

The present disclosure relates to a plasticizing device.

### 2. Related Art

JP-A-2022-20960 discloses a configuration of a molding device including a pressure detection section having a cylinder connected to a nozzle for supplying a plasticization material, a rod slidably disposed in the cylinder, and a sensor section that detects the pressure of the plasticization material via the rod. During molding, the rod vibrates slightly in the cylinder, and the plasticization material accumulates in the gap between the cylinder and the rod.

However, in the configuration described in JP-A-2022-20960, when the plasticization material accumulated between the cylinder and the rod is scraped out, there is a problem that the sliding resistance between the cylinder and the rod increases and the detection accuracy of the pressure detection section decreases.

### SUMMARY

A plasticizing device includes a plasticizing section

that melts the molding material by heat to generate a plasticization material; a flow path through which the plasticization material flows; a pressure detection section that includes a cylinder connected to the flow path and a plunger pin slidably disposed in the cylinder and that detects a pressure of the plasticization material in the flow path; a suction and discharge section that is connected to the flow path on a downstream side of the pressure detection section and that is configured to suck the plasticization material; a delivery amount adjustment section that adjusts a flow rate of the plasticization material flowing through the flow path and delivers the plasticization material from a nozzle to a stage; and a control section that controls at least one of the plasticizing section, the pressure detection section, the suction and discharge section, and the delivery amount adjustment section, wherein the control section causes the plunger pin to stroke at least one of before and after molding of the molded object.

### BRIEF DESCRIPTION OF THE DRAWINGS

FIG. 1 is a schematic view illustrating a configuration

of a three dimensional molding device as a plasticizing device.

FIG. 2 is a perspective view illustrating a configuration of a groove forming surface side of a screw.

FIG. 3 is a plan view illustrating a configuration of a barrel on a side screw facing surface.

FIG. 4 is a cross-sectional view illustrating a configuration of a pressure detection section.

FIG. 5 is a cross-sectional view of the pressure detection section illustrated in FIG. 4 taken along line V-V.

FIG. 6 is a flowchart showing a life extending operation method of the pressure detection section.

FIG. 7 is a cross-sectional view illustrating a part of a life extending operation method of the pressure detection section.

FIG. 8 is a cross-sectional view illustrating a part of a life extending operation method of the pressure detection section.

FIG. 9 is a cross-sectional view illustrating a part of a life extending operation method of the pressure detection section.

FIG. 10 is a graph showing a responsiveness of the pressure detection value.

### DESCRIPTION OF EMBODIMENTS

Hereinafter, a configuration of a three dimensional molding device 100 as a plasticizing device will be described with reference to the drawings. In the following drawings, three axes orthogonal to each other are described as an X axis, a Y axis, and a Z axis. A direction along the X axis is defined as an “X direction”, a direction along the Y axis is defined as a “Y direction”, a direction along the Z axis is defined as a “Z direction”, a direction of an arrow is defined as a +direction, and a direction opposite to the +direction is defined as a −direction. Note that viewing from the +Z direction or the −Z direction is also referred to as plan view or planar.

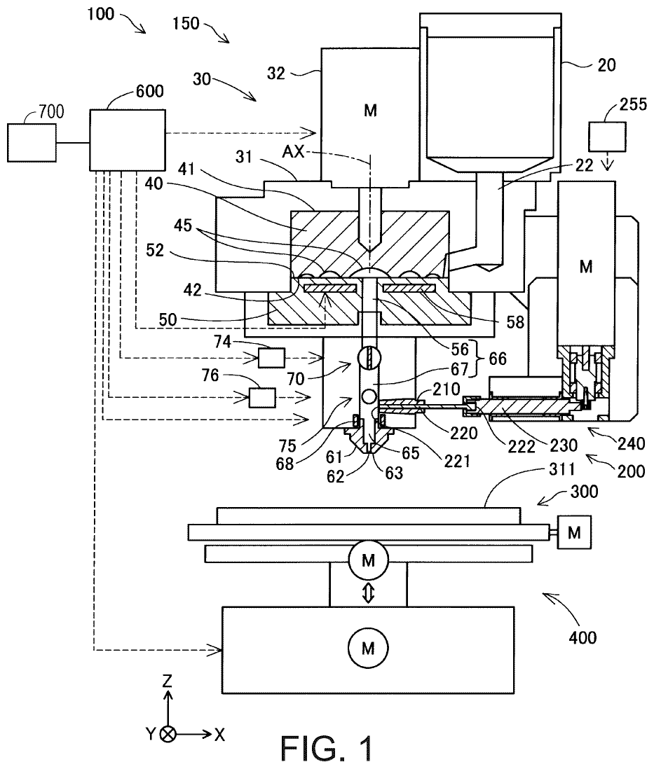

First, a configuration of a three dimensional molding device 100 will be described with reference to FIG. 1.

As illustrated in FIG. 1, the three dimensional molding device 100 includes a material delivery device 150, a stage 300, a position change section 400, a control section 600, and a notification section 700.

The control section 600 controls the operation of the entire three dimensional molding device 100 to execute molding processing for molding a molded object. The control section 600 is configured by a computer including one or a plurality of processors and a main storage device. The control section 600 exhibits various functions by the processor executing a program read into the main storage device.

The control section 600 controls at least one of the plasticizing section 30, the pressure detection section 200, the suction and discharge section 75, and the delivery amount adjustment section 70. Note that some of the functions of the control section 600 may be realized by a hardware circuit. In the molding processing executed by the control section 600, the material delivery device 150 and the position change section 400 are controlled in accordance with the molding data of the molded object.

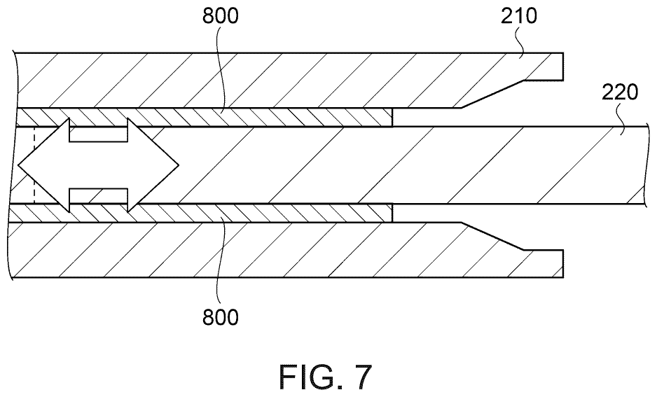

Under the control of the control section 600, The material delivery device 150 feeds a plasticization material 800 (see FIG. 7), which is obtained by melting a material in a solid state into a paste state, to the outside. The material delivery device 150 discharges the plasticization material 800 onto a stage 300 for molding, which serves as a base for the molded object.

The material delivery device 150 includes a material supply section 20 that is the supply source of the material before it is converted into a plasticization material 800, a plasticizing section 30 that plasticizes the material by rotation of a screw 40 to generate the plasticization material 800, a flow path 66 through which the generated plasticization material 800 flows, a nozzle 61 that communicates with the flow path 66 and feeds the plasticized material 800 to the outside, and a pressure detection section 200 that is connected to the flow path 66 and that detects a pressure of the plasticization material 800 in the flow path 66. Further, the flow path 66 is provided with a delivery amount adjustment section 70 and is connected to a suction and discharge section 75.

The material supply section 20 stores the material in a state of pellets, powder, or the like. In the present embodiment, ABS resin formed in a pellet shape is used as the material. The material supply section 20 is configured by a hopper. A supply path 22 that connects the material supply section 20 and the plasticizing section 30 is provided below the material supply section 20. The material supply section 20 supplies the material to the plasticizing section 30 via the supply path 22.

The plasticizing section 30 includes a screw case 31, a drive motor 32, a screw 40, a barrel 50, and a plasticization heater 58. The plasticizing section 30 use the rotation of the screw 40 to plasticize at least a part of the material supplied from the material supply section 20, and generates a pasty plasticization material 800 having fluidity. The plasticizing section 30 supplies the generated plasticization material 800 to the nozzle 61 via a flow path 66 provided between the screw 40 and the nozzle 61.

“Plasticization” is a concept including melting, and is a change from a solid to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point. The screw 40 is a so-called flat screw, and may be referred to as a “scroll”.

The screw case 31 is a housing for accommodating the screw 40. The barrel 50 is fixed to the lower surface of the screw case 31, and the screw 40 is accommodated in a space surrounded by the screw case 31 and the barrel 50. The screw 40 has a groove forming surface 42 in which grooves 45 are formed on a surface facing the barrel 50.

A drive motor 32 is fixed to the top surface of the screw case 31. The rotation shaft of the drive motor 32 is connected to the top surface 41 side of the screw 40. The drive motor 32 may not be directly connected to the screw 40, and for example, the screw 40 and the drive motor 32 may be connected via a speed reducer. The drive motor 32 is driven under the control of the control section 600.

The barrel 50 is disposed below the screw 40. The barrel 50 has a screw facing surface 52 facing the groove forming surface 42 of the screw 40. The barrel 50 is provided with a communication hole 56 on the central axis AX of the screw 40. The communication hole 56 forms a part of the flow path 66 described above.

More specifically, the flow path 66 is formed by the communication hole 56 and the supply flow path 67. The supply flow path 67 is a flow path that connects the communication hole 56 and the nozzle 61. The supply flow path 67 may not be provided, and the communication hole 56 and the nozzle 61 may be directly connected to each other.

The plasticization heater 58 is built into the barrel 50 at a position facing the grooves 45 of the screw 40. The plasticization heater 58 heats the material supplied between the screw 40 and the barrel 50. The temperature of the plasticization heater 58 is controlled by the control section 600.

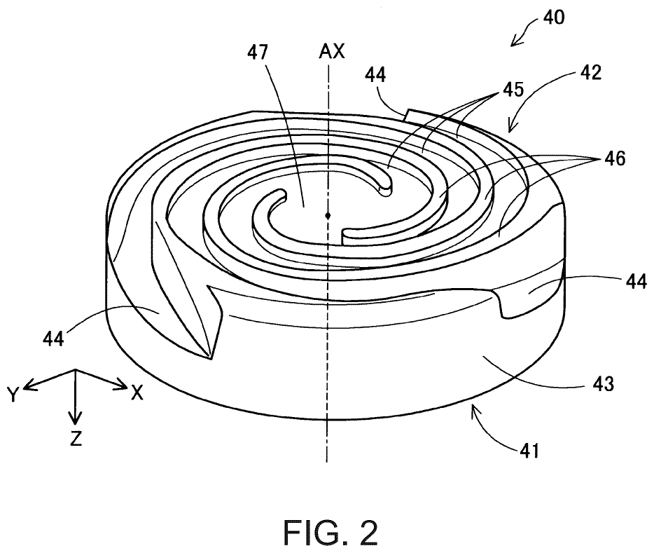

Next, the configuration of the screw 40 will be described with reference to FIG. 2.

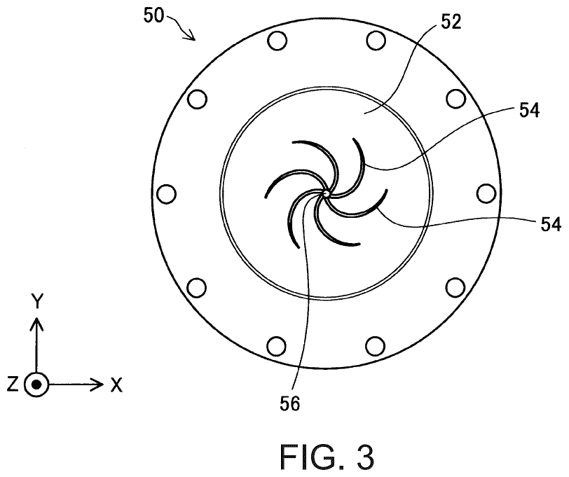

As illustrated in FIG. 2, the center section 47 of the groove forming surface 42 of the screw 40 is configured as a recess to which one end of each of the grooves 45 is connected. As illustrated in FIG. 3, the center section 47 faces the communication hole 56 of the barrel 50. The center section 47 intersects the central axis AX.

The grooves 45 constitute so-called scroll grooves. The grooves 45 extend in a spiral shape so as to draw an arc from the center section 47 toward the outer periphery of the screw 40. The groove forming surface 42 is provided with convex sections 46 that constitute a side wall sections of the grooves 45 and that extend along each groove 45. The grooves 45 are continuous to the material inlet 44 formed in the side surface 43 of the screw 40.

The material inlet 44 is a portion that receives the material supplied via the supply path 22 of the material supply section 20. The material received by the material inlet 44 is fed between the screw 40 and the barrel 50.

As illustrated in FIG. 2, three grooves 45 are formed so as to be separated by the convex sections 46. The number of grooves 45 is not limited to three, and may be one or two or more. The grooves 45 are not limited to a vortex shape, but may be a spiral shape or an involute curve shape, or may be a shape extending so as to draw an arc from the center section 47 toward the outer periphery.

Next, the configuration of the barrel 50 on the screw facing surface 52 side will be described with reference to FIG. 3.

As illustrated in FIG. 3, a communication hole 56 is formed in the center of the screw facing surface 52. A plurality of guide grooves 54 are formed around the communication hole 56 in the screw facing surface 52.

Each of the guide grooves 54 has one end connected to the communication hole 56 and extends in a spiral shape from the communication hole 56 toward the outer periphery of the screw facing surface 52. Each of the guide grooves 54 has a function of guiding the plasticization material 800 to the communication hole 56. Note that one end of the guide grooves 54 may not be connected to the communication hole 56. Also, the barrel 50 may not be formed with the guide grooves 54.

As illustrated in FIG. 1, the plasticizing section 30 heats the material supplied between the screw 40 and the barrel 50 while transporting the material toward the flow path 66 by the screw 40, the barrel 50, and the plasticization heater 58 described above to generate the plasticization material 800, and supplies the generated plasticization material 800 to the nozzle 61 via the flow path 66.

The nozzle 61 includes a nozzle flow path 65 and a tip end surface 63 provided with a nozzle opening 62. The nozzle flow path 65 is a flow path of the plasticization material 800 formed in the nozzle 61, and connect to the flow path 66 described above.

Specifically, the nozzle flow path 65 is connected to the supply flow path 67 described above. The tip end surface 63 is a surface constituting a tip portion of the nozzle 61 protruding in the-Z direction toward the molding surface 311. The nozzle opening 62 is a portion that is provided at the end portion of the nozzle flow path 65 on a side connecting to atmosphere and that has a reduced flow path cross section of the nozzle flow path 65. The plasticization material 800 generated by the plasticizing section 30 is supplied to the nozzle 61 via the flow path 66 and is ejected from the nozzle opening 62 via the nozzle flow path 65.

A nozzle heater 68 is provided around the nozzle flow path 65. The nozzle heater 68 heats the nozzle 61 and heats the plasticization material 800 in the nozzle flow path 65 under the control of the control section 600.

The control section 600 can adjust the fluidity of the plasticization material 800 in the nozzle flow path 65 by controlling the output of the nozzle heater 68. The set temperature of the nozzle heater 68 is set to a temperature higher than the set temperature of the plasticization heater 58 of the plasticizing section 30 described above.

The delivery amount adjustment section 70 adjusts the flow rate of the plasticization material 800 delivered from the nozzle opening 62. The flow rate of the plasticization material 800 delivered from the nozzle opening 62 to the outside may be referred to as a delivery amount. The delivery amount adjustment section 70 is configured by a butterfly valve that changes the opening degree of the flow path 66 by rotating in the flow path 66, and is disposed in the supply flow path 67 of the flow path 66.

The delivery amount adjustment section 70 is driven by a first drive section 74 configured by a stepping motor or the like under the control of the control section 600. The control section 600 adjusts the opening degree of the flow path 66 by controlling the rotation angle of the butterfly valve using the first drive section 74.

Accordingly, the control section 600 can adjust the flow rate of the plasticization material 800 flowing from the plasticizing section 30 to the nozzle 61 and adjust the delivery amount. The delivery amount adjustment section 70 can also set the delivery amount to 0 by setting the opening degree of the flow path 66 to 0. That is, the delivery amount adjustment section 70 adjusts the delivery amount and controls on/off of delivery of the plasticization material 800.

The suction and discharge section 75 is connected between the delivery amount adjustment section 70 and the nozzle opening 62 in the flow path 66. The suction and discharge section 75 performs a suction operation of sucking the plasticization material 800 in the flow path 66 and a discharge operation of pushing out the sucked plasticization material 800 toward the nozzle opening 62.

The suction and discharge section 75 is configured by a plunger. The suction and discharge section 75 retracts the plunger in a direction away from the flow path 66 in the suction operation described above, and advances the plunger in a direction approaching the flow path 66 in the discharge operation. The suction and discharge section 75 is driven by the second drive section 76 under the control of the control section 600.

The second drive section 76 is constituted by, for example, a stepping motor and a rack and pinion mechanism that converts the rotational force of the stepping motor into the translational movement of the plunger.

The control section 600 suppresses the tailing phenomenon in which the plasticization material 800 hangs like a string from the nozzle opening 62 by performing a suction operation using the suction and discharge section 75 when stopping the delivery of the plasticization material 800 from the nozzle 61.

In this case, the control section 600 can more effectively suppress the tailing phenomenon by executing the suction operation after the opening degree of the flow path 66 is set to 0 by the delivery amount adjustment section 70. The suction and discharge section 75 performs a discharge operation when starting or restarting the discharge of the plasticization material 800 from the nozzle 61, thereby improving the responsiveness of the discharge of the plasticization material 800 from the nozzle 61.

In this case, the control section 600 executes the suction operation before the opening degree of the flow path 66 is made larger than 0 by the delivery amount adjustment section 70, and thus, it is possible to further improve the responsiveness of the delivery of the plasticization material 800.

The stage 300 is disposed at a position facing the tip end surface 63 of the nozzle 61. The three dimensional molding device 100 delivers the plasticization material 800 from the nozzle 61 toward the molding surface 311 of the stage 300 and stacks layers of the plasticization material 800 to mold a molded object.

The position change section 400 changes the relative position between the nozzle 61 and the stage 300 by changing the relative position between the material delivery device 150 and the stage 300. The position change section 400 moves the stage 300 with respect to the material delivery device 150.

Note that the change in the relative position of the material delivery device 150 or the nozzle 61 with respect to the stage 300 may be simply referred to as movement of the material delivery device 150 or the nozzle 61. That is, for example, movement of the stage 300 in the +X direction can be called movement of the material delivery device 150 or the nozzle 61 in the −X direction.

The position change section 400 is configured by a three axis positioner that moves the stage 300 in three axial directions of the X, Y, and Z directions by driving forces of three motors. Each motor is driven under the control of the control section 600. The position change section 400 may be configured to move the material delivery device 150 without moving the stage 300, instead of moving the stage 300. The position change section 400 may be configured to move both the stage 300 and the material delivery device 150.

The notification section 700 notifies the user whether or not the pressure detection value of the pressure detection section 200 is normal. Examples of the notification section 700 include a monitor, a lamp, and a buzzer. The notification section 700 of the present embodiment is a monitor.

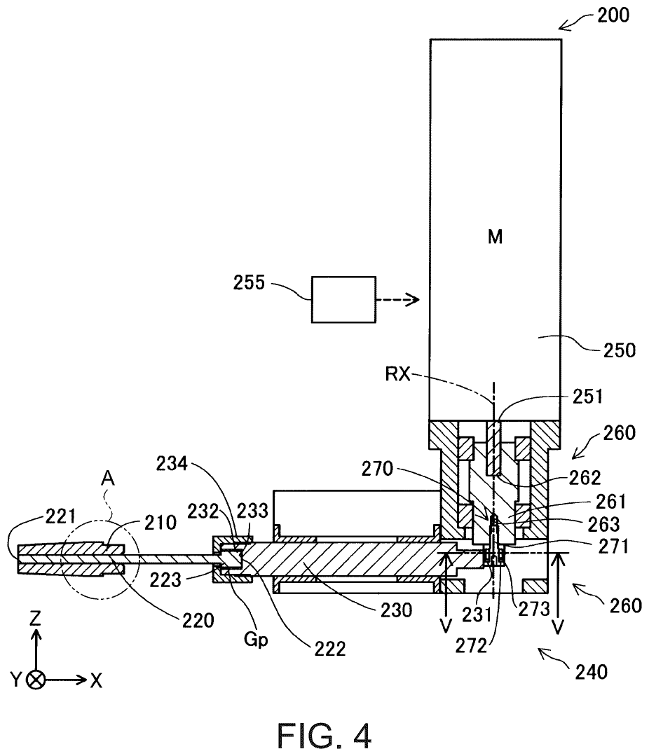

Next, the configuration of the pressure detection section 200 will be described with reference to FIG. 4.

The pressure detection section 200 includes a cylinder 210 connected to the flow path 66, a plunger pin 220 inserted into the cylinder 210, a transmission member 230 connected to the plunger pin 220, and a measurement section 240 that measures the pressure of the plasticization material 800 in the flow path 66 via the plunger pin 220 and the transmission member 230.

The cylinder 210 has a tubular shape with its axial direction as a longitudinal direction. As illustrated in FIGS. 1 and 4, the cylinder 210 is disposed such that the longitudinal direction thereof is along the X direction. As illustrated in FIG. 1, the end portion of the cylinder 210 in the −X direction is open in the −X direction toward the flow path 66. The end portion of the cylinder 210 in the +X direction is located in the +X direction of the flow path 66. The flow path 66 communicates with the outside of the flow path 66 in the X direction via the cylinder 210.

The cylinder 210 is connected to the flow path 66 (see FIG. 1) downstream of the delivery amount adjustment section 70. The cylinder 210 is connected to the flow path 66 downstream of the suction and discharge section 75. The cylinder 210 may be connected to, for example, the upstream side of the suction and discharge section 75 in the flow path 66.

The plunger pin 220 has a shaft shape with its axial direction as a longitudinal direction. The plunger pin 220 is formed of tool steel. As illustrated in FIGS. 1 and 4, the plunger pin 220 is inserted into the cylinder 210 such that the longitudinal direction thereof is along the X direction.

The plunger pin 220 has a pin end face 221 and a transmission section 222 that is farther in the X direction from the flow path 66 than the pin end face 221. The pin end face 221 is an end face of the plunger pin 220 in the-X direction. As illustrated in FIG. 1, the pin end face 221 faces the flow path 66 in the cylinder 210.

The transmission section 222 is an end face on the opposite side of the plunger pin 220 than the pin end face 221 in the longitudinal direction, and is an end face in the +X direction of the plunger pin 220. The plunger pin 220 has a connection section 223 at the end portion in the +X direction that has a diameter larger than that of the other portions of the plunger pin 220 in the X direction. The transmission section 222 is the +X direction end face of the connection section 223. As illustrated in FIGS. 1 and 4, the transmission section 222 is in contact with the transmission member 230 in the X direction at a position in the +X direction of the cylinder 210.

The interval between the side surface of the plunger pin 220 and the inner side surface of the cylinder 210 is, for example, 50 μm or less from the viewpoint of suppressing the leakage of the plasticization material 800 in the flow path 66 to the outside through gaps between the plunger pin 220 and the cylinder 210.

As illustrated in FIGS. 1 and 4, the transmission member 230 is disposed between the plunger pin 220 and the measurement section 240 in the X direction. The transmission member 230 is formed of stainless steel. An end face 231 of the transmission member 230 in the +X direction is in contact with the measurement section 240.

As illustrated in FIG. 4, a concave section 232 that opens in the −X direction is formed in the end portion of the transmission member 230 in the −X direction. The +X direction tip portion of the plunger pin 220 is inserted into the opening of the concave section 232. In the opening of the concave section 232, the transmission section 222 of the plunger pin 220 is in contact with the bottom section 233 of the concave section 232 in the X direction.

The plunger pin 220 and the transmission member 230 are coupled by a joint 234 that covers a side surface of the-X direction end portion of the transmission member 230. The joint 234 has a shape that engages with a surface of the connection section 223 of the plunger pin 220 in the −X direction, and restricts the movement of the plunger pin 220 in the −X direction with respect to the transmission member 230.

A gap Gp is formed between the side surface of the connection section 223 of the plunger pin 220 and the inner side surface of the concave section 232. Therefore, the plunger pin 220 contacts the transmission member 230 in the X direction, but does not contact in the Y direction or the Z direction. A gap is also formed between the side surface of the plunger pin 220 and the connection section 223.

The plunger pin 220 transmits the pressure of the plasticization material 800 in the flow path 66 to the measurement section 240. More specifically, the plunger pin 220 receives a force in the +X direction on the pin end face 221 due to the pressure of the plasticization material 800 in the flow path 66, and transmits the force to the transmission member 230 via the transmission section 222. The force transmitted to the transmission member 230 via the transmission section 222 is transmitted to the measurement section 240 via the end face 231 of the transmission member 230. Hereinafter, the force transmitted to the measurement section 240 via the transmission section 222 in this manner may be referred to as a detection force.

The measurement section 240 includes a motor 250 having an output shaft 251, and a torque member 260 connected to the output shaft 251.

The motor 250 is disposed with the output shaft 251 facing the −Z direction so that the output shaft 251 is along the Z direction which is orthogonal to the longitudinal direction of the plunger pin 220. The motor 250 is configured by a servo motor. The measurement section 240 includes a controller 255 for servo-controlling the motor 250. The driving of the motor 250 is controlled by the control section 600 via the controller 255.

The controller 255 performs position holding control for performing feedback control so as to hold the rotational position of the output shaft 251. More specifically, when torque is applied to the output shaft 251 from the outside in a state where the driving of the motor 250 is stopped, the controller 255 regulates a change in the rotational position of the output shaft 251 by generating torque in the opposite direction to the torque in the output shaft 251.

When the rotational position of the output shaft 251 is changed by the torque applied from the outside, the rotational position of the output shaft 251 is returned to the original position by generating torque in the opposite direction to the torque in the output shaft 251 in the same manner. Such position holding control is sometimes called a servo lock. Hereinafter, the torque for holding the rotational position of the output shaft 251 in the position holding control may be referred to as a position holding torque.

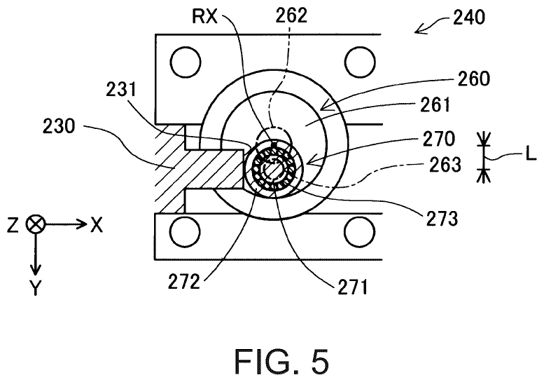

Next, a pressure detection method will be described with reference to FIG. 5.

As illustrated in FIG. 5, the torque member 260 has a connecting section 261 and a force receiving section 270.

The connecting section 261 is a substantially columnar member disposed along the Z direction. The connecting section 261 is formed with a connection hole 262 for connecting the output shaft 251 of the motor 250 and a fixing hole 263 for fixing the force receiving section 270.

The connection hole 262 is open in the +Z direction at the end portion of the connecting section 261 in the +Z direction (see FIG. 4). The fixing hole 263 is open in the −Z direction at the end portion of the connecting section 261 in the −Z direction. In FIG. 5, the position of the connection hole 262 in the X direction and the Y direction is indicated in two dot chain line, and similarly, the position of the fixing hole 263 is indicated single dot chain line.

The connection hole 262 is formed in the center of the connecting section 261 when viewed along the Z direction. The fixing hole 263 is formed at a position shifted from the center of the connecting section 261 when viewed along the Z direction. Therefore, the fixing hole 263 is located at a position shifted from the rotation axis RX of the output shaft 251 when viewed along the Z direction.

As illustrated in FIG. 5, the force receiving section 270 is formed by a cam follower and includes a shaft 271 and an outer ring 272. The end portion of the shaft 271 in the +Z direction is inserted into the fixing hole 263 of the connecting section 261 described above. The outer ring 272 is supported by a bearing 273 fixed to a side surface of the shaft 271 so as to be rotatable on the shaft 271. The outer ring 272 and the bearing 273 are disposed in the −Z direction of the connecting section 261.

The fixing hole 263 is formed at a position shifted from the rotation axis RX. Therefore, as illustrated in FIG. 5, the force receiving section 270 is disposed at a position shifted from the rotation axis RX when viewed along the Z direction. More specifically, the force receiving section 270 is disposed at a position shifted from the rotation axis RX in the +Y direction by a distance L when viewed along the Z direction.

The torque member 260 receives the detection force described above and applies a torque by the detection force to the output shaft 251. The torque member 260 generates a rotational force for rotating the connecting section 261 connected to the output shaft 251 by receiving the detection force at the outer ring 272 of the force receiving section 270, and applies a torque generated by the rotational force to the output shaft 251. Hereinafter, the torque generated by the detection force applied to the output shaft 251 may be referred to as a detection torque.

The measurement section 240 detects the pressure of the plasticization material 800 in the flow path 66 based on the current value or the voltage value of the motor 250 generated by the detection torque applied to the output shaft 251. More specifically, while the above-mentioned controller 255 is performing position holding control, the measurement section 240 detects a voltage value for generating a position holding torque corresponding to the detection torque, and detects the pressure of the plasticization material 800 in the flow path 66 based on the detected voltage value. Accordingly, the measurement section 240 can detect the pressure while regulating the movement of the plunger pin 220 and the transmission member 230 in the +X direction.

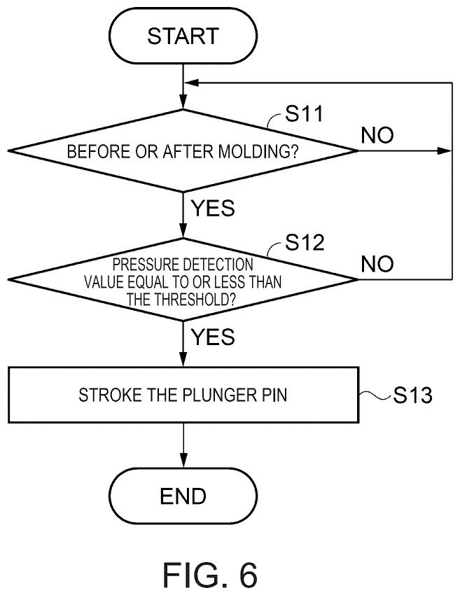

Next, a life extending operation method of the pressure detection section 200 will be described with reference to FIGS. 6 to 10. Note that FIGS. 7 to 9 illustrate an enlargement of portion A of the pressure detection section 200 illustrated in FIG. 4.

A life extension operation refers to maintaining the detection accuracy of the measurement section 240 by suppressing the sliding resistance between the cylinder 210 and the plunger pin 220 constituting the pressure detection section 200, that is, by suppressing partial contact of the plunger pin 220 against the cylinder 210.

As illustrated in FIG. 6, first, in step S11, the control section 600 determines whether the three dimensional molding device 100 has molded the molded object. If before or after molding the object, then the process proceeds to step S12. If the object is presently being molded, then step S11 is repeated.

Next, in step S12, the control section 600 determines whether or not the pressure detection value of the pressure detection section 200 is equal to or less than a threshold value. The threshold value of the pressure detection value is the value of the measurement section 240 of the pressure detection section 200 when the plunger pin 220 properly slides in the cylinder 210.

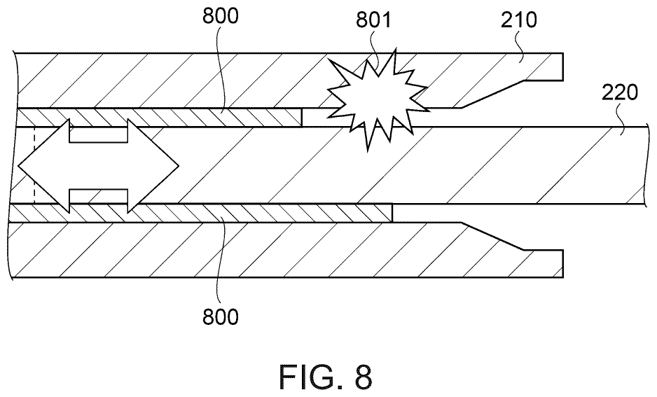

If the detected pressure value is below the threshold value, then when the plunger pin 220 slides within the cylinder 210, that is, when it vibrates slightly, for example, if there is contact on one side because the plasticization material 800 was scraped out (see FIG. 8), the process proceeds to step S13. In FIG. 8, the portion in which partial contact occurs is illustrated as a partial contact section 801. If the pressure detection value is equal to or greater than the threshold value, that is, if the plunger pin 220 is sliding properly within the cylinder 210 (see FIG. 7), the process proceeds to step S11.

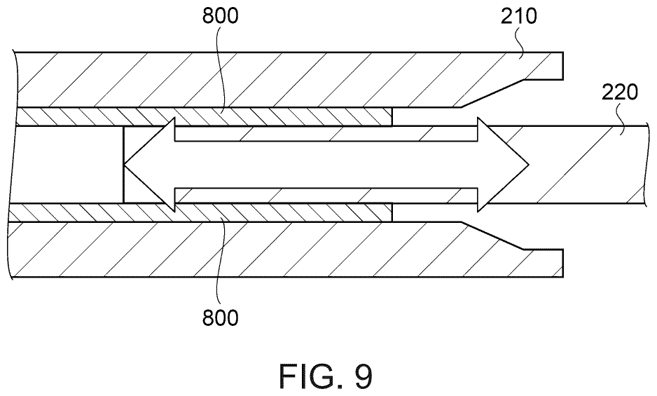

Next, in the step S13, the plunger pin 220 is stroked once. Specifically, since the sliding resistance between the cylinder 210 and the plunger pin 220 is high, that is, the plunger pin 220 is in a state of partial contact in the cylinder 210, the plunger pin 220 is stroked by a larger amount than the sliding range during molding (see FIG. 9).

Accordingly, the plasticization material 800 can be uniformly disposed in the gap between the cylinder 210 and the plunger pin 220, in other words, the plasticization material 800 can be disposed in the entire cylinder 210, and thus, it is possible to suppress contact between the cylinder 210 and the plunger pin 220, that is, partial contact between the cylinder 210 and the plunger pin 220. In other words, the plasticization material 800 can be supplied to a portion where the plunger pin 220 is in partial contact with the inside of the cylinder 210. Therefore, it is possible to suppress an increase in sliding resistance between the cylinder 210 and the plunger pin 220, and it is possible to suppress a decrease in detection accuracy of the pressure detection section 200.

Examples of the stroke parameter include the moving speed of the plunger pin 220, the stroke amount of the plunger pin 220, and the number of strokes of the plunger pin 220. Therefore, the control section 600 preferably causes the plunger pin 220 to stroke based on at least one of these parameters.

When the pressure detection value is equal to or less than the threshold value, the plunger pin 220 is stroked, so that the detected pressure value can always be maintained close to the threshold value, thereby suppressing a decrease in the detection accuracy of the pressure detection section 200.

Since the plunger pin 220 is stroked not during the molding but at least one of before and after molding of the molded object, the sliding operation between the cylinder 210 and the plunger pin 220 can be brought into an optimal state without providing time for newly performing the stroke. Examples of the time during which the molding is not performed include a time during a purge process of purging the remaining resin in the flow path 66.

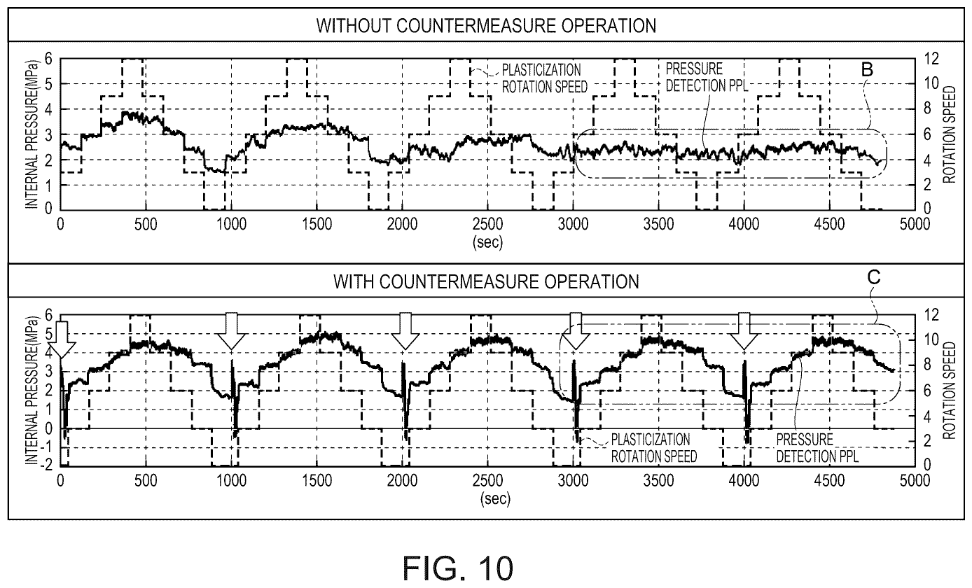

FIG. 10 illustrates the relationship between the pressure detection PPL (MPa), that is, the pressure detection value, and the plasticization rotation speed, comparing before the life extension operation is performed and after the life extension operation is performed. The horizontal axis represents the elapsed time (sec) during the molding. Downward arrows in “with countermeasure operation” indicate timings at which the plunger pin 220 is stroked. The plasticization rotation speed is the repetition of vertical movements during a constant period. When the plasticization rotation speed is increased, the pressure detection value increases. When the plasticization rotation speed is decreased, the pressure detection value decreases.

In “without countermeasure operation”, which is the upper graph of FIG. 10, it can be seen that the pressure detection value gradually becomes a flat state as time elapses as shown in a portion B, and the pressure detection section 200 does not properly respond.

In “with countermeasure operation”, which is the graph on the lower side of FIG. 10, even after time elapses, as shown in a portion C, the same protruding shape as that at the beginning is seen in the pressure detection value, and it can be seen that the pressure detection section 200 properly responds.

As described above, the three dimensional molding device 100 includes the plasticizing section 30 that melts the molding material by heat to generate the plasticization material 800; the flow path 66 through which the plasticization material 800 flows; the pressure detection section 200 that includes the cylinder 210 connected to the flow path 66 and the plunger pin 220 slidably disposed in the cylinder 210 and that detects the pressure of the plasticization material 800 in the flow path 66; the suction and discharge section 75 that is connected to the flow path 66 on the downstream side of the pressure detection section 200 and that is configured to suck the plasticization material 800; the delivery amount adjustment section 70 that adjusts the flow rate of the plasticization material 800 flowing through the flow path 66 and that delivers the plasticization material 800 from the nozzle 61 to the stage 300; and the control section 600 that controls at least one of the plasticizing section 30, the pressure detection section 200, the suction and discharge section 75, and the delivery amount adjustment section 70, wherein the control section 600 causes the plunger pin 220 to stroke at least one of before and after molding of the molded object.

According to this configuration, since the plunger pin 220 is stroked before or after molding, the plasticization material 800 can be uniformly disposed in the gap between the cylinder 210 and the plunger pin 220, in other words, the plasticization material 800 can be disposed in the entire cylinder 210, and contact between the cylinder 210 and the plunger pin 220, that is, partial contact can be suppressed. Therefore, it is possible to suppress an increase in sliding resistance between the cylinder 210 and the plunger pin 220, and it is possible to suppress a decrease in detection accuracy of the pressure detection section 200. In addition, the life of the pressure detection section 200 can be extended, and maintenance can be reduced.

In the three dimensional molding device 100 of the present embodiment, it is desirable that the control section 600 causes the plunger pin 220 to stroke based on at least one parameter of the speed of the plunger pin 220, the stroke amount of the plunger pin 220, and the number of strokes of the plunger pin 220.

According to this configuration, since the plunger pin 220 is moved based on the above-described parameters, the plasticization material 800 can be uniformly disposed in the gap between the cylinder 210 and the plunger pin 220, and contact due to partial contact between the cylinder 210 and the plunger pin 220 can be suppressed.

In the three dimensional molding device 100 of the present embodiment, it is desirable that the control section 600 causes the plasticization material 800 to flow through the flow path 66, and causes the plunger pin 220 to perform a stroke in a case where the pressure detection value of the pressure detection section 200 is equal to or less than the threshold value.

According to this configuration, when the pressure detection value is below the threshold value, the plunger pin 220 is stroked, so that the pressure detection value can always be maintained close to the threshold value, thereby suppressing a decrease in the detection accuracy of the pressure detection section 200.

In the three dimensional molding device 100 of the present embodiment, it is desirable that the control section 600 executes the purge process of purging the residual resin in the flow path 66 at least one of before and after molding of the molded object, and causes the plunger pin 220 to stroke during the purge process.

According to this configuration, since the plunger pin 220 is stroked during the purge process, which is not related to molding, the sliding operation between the cylinder 210 and the plunger pin 220 can be optimized without providing a new time.

Hereinafter, a modification of the above-described embodiment will be described.

As described above, when the pressure detection value is equal to or less than the threshold value, the plunger pin 220 is not limited to being stroked, and the torque of the motor 250 that drives the plunger pin 220 may be increased. Torque refers to the torque value when the motor 250 is rotated to push the plunger pin 220 toward the flow path 66.

Thus, in the modified three dimensional molding device 100, it is preferable that the control section 600 causes the plasticization material 800 to flow into the flow path 66, and when the pressure detection value of the pressure detection section 200 is equal to or less than the threshold value, increases the torque of the motor 250 that drives the plunger pin 220. According to this configuration, when the pressure detection value is equal to or less than the threshold value, the torque of the motor 250 that drives the plunger pin 220 is increased, so that the plunger pin 220 can be caused to slide during molding, that is, to perform an operation different from slight vibration, specifically, to stroke with a stroke amount. Therefore, it is possible to uniformly dispose the plasticization material 800 in the gap between the cylinder 210 and the plunger pin 220, and it is possible to suppress contact due to partial contact between the cylinder 210 and the plunger pin 220.

As described above, the plunger pin 220 is not limited to be stroked once when the pressure detection value is equal to or less than the threshold value, and the plunger pin 220 may be continuously stroked until the pressure detection value of the pressure detection section 200 becomes equal to or greater than the threshold value.

As described above, in the three dimensional molding device 100 of the modification, it is desirable that the control section 600 causes the plasticization material 800 to flow through the flow path 66 and continues to stroke the plunger pin 220 until the pressure detection value of the pressure detection section 200 becomes equal to or greater than the threshold value.

According to this configuration, since the stroke operation of the plunger pin 220 is repeated until the pressure detection value becomes equal to or greater than the threshold value, it is possible to uniformly dispose the plasticization material 800 in the gap between the cylinder 210 and the plunger pin 220, and it is possible to suppress the contact due to the partial contact between the cylinder 210 and the plunger pin 220.

As described above, it is not limited to the case where the plunger pin 220 is stroked when the pressure detection value is equal to or less than the threshold value, and the notification section 700 may stop the stroke during the stroke of the plunger pin 220 or stop the stroke when the pressure detection value becomes equal to or greater than the threshold value, and may notify that there is no abnormality in the pressure detection section 200. The notification section 700 may display the information on a monitor provided in the three dimensional molding device 100. The presence of abnormality and the absence of abnormality may be displayed in a distinguished manner by changing the color of the lamp. A buzzer may be sounded in the case of an abnormality.

As described above, in the three dimensional molding device 100 of the modification, it is desirable that a notification section 700 is provided that notifies whether or not there is an abnormality in the pressure detection section 200,

the control section 600 causes the plasticization material 800 to flow through the flow path 66, and when the pressure detection value becomes equal to or greater than the threshold value, stops the stroke of the plunger pin 220 and notifies the notification section 700 that there is no abnormality in the pressure detection section 200.

According to this configuration, when the pressure detection value becomes equal to or greater than the threshold value, the stroke of the plunger pin 220 is stopped, and thus it is possible to suppress the plunger pin 220 from being stroked more than necessary. Since the notification section 700 is caused to notify that there is no abnormality, the user can grasp the state of the pressure detection section 200 by checking the state using the notification section 700.

As described above, the three dimensional molding device 100 has been described as an example of the plasticizing device, but the plasticizing device is not limited thereto, and the pressure detection section 200 described above may be applied to an injection molding machine, for example. In addition, in the three dimensional molding device 100, the same configuration can be applied to a portion similar to the relationship between the cylinder 210 and the plunger pin 220.

What is claimed is:

1. A plasticizing device comprising:
a plasticizing section that melts the molding material by heat to generate a plasticization material;
a flow path through which the plasticization material flows;
a pressure detection section that includes a cylinder connected to the flow path and a plunger pin slidably disposed in the cylinder and that detects a pressure of the plasticization material in the flow path;
a suction and discharge section that is connected to the flow path on a downstream side of the pressure detection section and that is configured to suck the plasticization material;
a delivery amount adjustment section that adjusts a flow rate of the plasticization material flowing through the flow path and that delivers the plasticization material from a nozzle to a stage; and
a control section that controls at least one of the plasticizing section, the pressure detection section, the suction and discharge section, and the delivery amount adjustment section, wherein
the control section causes the plunger pin to stroke at least one of before and after molding of the molded object.

2. The plasticizing device according to claim 1, wherein
the control section causes the plunger pin to stroke based on at least one parameter of a speed of the plunger pin, a stroke amount of the plunger pin, and a stroke frequency of the plunger pin.

3. The plasticizing device according to claim 1, wherein
the control section causes the plasticization material to flow through the flow path and causes the plunger pin to stroke when a pressure detection value of the pressure detection section is equal to or less than a threshold value.

4. The plasticizing device according to claim 1, wherein
the control section causes the plasticization material to flow through the flow path and increases a torque of a motor that drives the plunger pin when a pressure detection value of the pressure detection section is equal to or less than a threshold value.

5. The plasticizing device according to claim 1, wherein
the control section causes the plasticization material to flow through the flow path and continues to cause the plunger pin to stroke until the pressure detection value of the pressure detection section becomes equal to or greater than a threshold value.

6. The plasticizing device according to claim 5, further comprising:
a notification section that notifies whether or not there is an abnormality in the pressure detection section, wherein
the control section causes the plasticization material to flow through the flow path and when the pressure detection value becomes equal to or greater than a threshold value, stops a stroke of the plunger pin and notifies the notification section that there is no abnormality in the pressure detection section.

7. The plasticizing device according to claim 1, wherein
the control section is configured to execute a purge process of purging a remaining resin in the flow path at least one of before molding and after molding of the molded object, and to cause the plunger pin to stroke during the purge process.
